(19) United States
(12) Patent Application Publication
(10) Pub. No.: US 2006/0249240 A1
(43) Pub. Date: Nov. 9, 2006

(54) Backing paper control

(76) Inventor: Gerard Dijkstra, Goteborg (SE)

Correspondence Address: HARNESS, DICKEY & PIERCE, P.L.C., P.O. BOX 8910, RESTON, VA, 20195, US

(21) Appl. No.: 11/418,111

(22) Filed: May 5, 2006

Related U.S. Application Data
(60) Provisional application No. 60/684,555, filed on May 26, 2005.
(60) Provisional application No. 60/678,797, filed on May 9, 2005.

(51) Int. Cl. B65C 9/42; B32B 41/00

(52) U.S. Cl. 156/64; 156/378; 156/361; 156/541; 156/249; 156/DIG. 45

(57) ABSTRACT

A system, method and computer program for removing faulty RFID tagged labels from a label applicator system wherein a RFID testing device detects faulty RFID tag whereby a tension on a label backing paper is reduced so as to increase a radius at a position of transferal of the labels from the label backing paper to a label applicator head. The increase in radius has the effect that the label is not transferred to the label applicator head but instead remains on the backing paper and thus will not be applied to a object to be labeled.

### PRIORITY CLAIM

This application claims priority to Provisional Application No. 60/684,555, filed May 9, 2005, the contents of which is incorporated herein in its entirety.

### FIELD OF THE INVENTION

The present invention relates to a device and system for controlling the motion of backing paper in a labeling application device, and in particular to a device allowing for controlled mounting of backing paper and rejecting of faulty labels.

### BACKGROUND OF THE INVENTION

In labeling application devices labels are situated on a backing paper which in turn is mounted on for instance a storage roll or reel at one end and on a collecting roll at the other end. There between one or several dancing arms keep the backing paper stretched. A problem with this type of construction is that when mounting the backing paper, it has to be mounted along a long path formed by all the dancing arms and other components controlling the path of the backing paper thereby leading to a waste of backing paper and labels, since the dancing arms are fixed in position. The physical length is determined by the complexity of the travel distance and number of dancing arms and their positions.

RFID (radio frequency identification) tags are more and more used in a widespread area of applications. They are used for uniquely identifying an object and wherein the identification can be read non-contacting using a radio transmitter. The RFID tag contains an antenna and a chip containing a unique code which can either be preprogrammed or inserted during an initiation process. Power is supplied wirelessly into the antenna and the chip responds to a query by submitting the programmed code or number.

In automated production processes it is an interest to mount such an RFID tag to every product and preferably in an inline process in order to obtain a quick and reliable production rate. However, the RFID tags may have a mixed quality meaning that some tags are not initiated or erroneous in some other way. Therefore it is of interest to during the inline production process or any other inline process test each RFID tag for quality assurance.

Many objects obtain a label for visible identification and/or specification or the product or box containing a product. It would be advantageously to provide a combined label and RFID tag.

Using such combined label and RFID tag product, it is of interest to have an inline testing and verification phase during labeling of products or boxes.

### SUMMARY OF THE INVENTION

The invention provides a simple and reliable solution for making the mounting of backing paper with labels attached to it easier and more cost effective, reducing the amount of backing paper that go to waste in the mounting process.

The invention also provides a simple and reliable solution for removing erroneous RFID tags located in or on labels. The solution test each label/RFID tag and controls transferring of labels in such a way that labels can be withheld from an applicator head and thus will not be applied to objects to be labeled.

In one embodiment of the present invention, a dancing arm is displaced in such a way as to reduce tension on a transport or backing paper whereupon labels are located. If the dancing arm is displaced at the correct moment, the label will not be transferred onto the applicator head and thus will be kept on the backing paper and later collected on a collecting roll.

In another embodiment of the present invention, a label applicator system with means for hindering a faulty RFID tagged label to be applied to an object to be labeled is provided, comprising:
a label applicator head;
a label comprising an RFID (Radio Frequency Identification) tag, the label stored on the label backing paper;
an RFID test device; and
means for applying tension in a backing paper, mounted in the label applicator system, with labels attached on the backing paper;
   wherein means for reducing tension is arranged to be operational if the RFID test device detects a faulty RFID tag.

The means for reducing tension comprise a second dancing arm applying a tension force on the backing paper and the second dancing arm arranged to be displaced to a tension reducing position when tension reduction is desired.

The second dancing arm may be located adjacent to a collecting roll collecting the backing paper downstream of the label applicator head.

The means for reducing tension comprise a backing roll arranged to apply a tension reducing force to the backing paper by applying a counteracting direction of travel on the backing paper.

The means for reducing tension further comprise means for applying a displacement stop of a dancing arm, wherein the dancing arm is hindered from increasing the tension when the backing roll apply the tension reducing force.

The means for reducing tension comprise a collecting unit, pulling the backing paper, being arranged to invert a direction of travel of the backing paper in order to reduce tension on the backing paper.

The means for reducing tension further comprise means for applying a displacement stop of a second dancing arm, wherein the second dancing arm is hindered from increasing the tension when the collecting roll inverts the direction of travel in order to reduce tension on the backing paper.

In yet another embodiment of the present invention, a method of hindering a faulty RFID tagged label from being applied to an object by a label applicator system is provided, comprising the steps of:
determining the quality of the RFID tag;
reducing tension on a label backing paper, mounted in the label applicator system, if the RFID tag is determined to be faulty;
obtaining from the step of reducing tension an increased turning radius of the label backing paper at a position of transferal to a label applicator head part of the label applicator system; and
hindering the label from being transferred to the label applicator head from the label backing paper.

The method may further comprise the step of displacing a second dancing arm to a tension reducing position from a tension applying position when tension reduction is desired, the second dancing arm is located downstream of the label applicator head.

In another embodiment of the present invention, a computer program for controlling a label applicator system applying RFID tagged labels to objects is provided, comprising:
an instruction set for receiving a signal from an RFID testing device;
an instruction set for sending a signal to an actuator controlling a tension controlling device controlling tension on a label backing paper;
an instruction set for sending a signal to the actuator indicative of a reduction of tension on the label backing paper if the RFID testing device detects a faulty RFID tag.

Still another embodiment of the present invention, a label applicator system with means for facilitating mounting of label backing paper is provided, comprising:
a storage roll;
a collecting roll;
a first dancing arm located close to the storage roll;
a second dancing arm located close to the collecting roll;
a label applicator head; and
   a backing paper with labels attached,
   wherein the backing paper is attached at one end to the storage roll, and mounted in a path passing the first dancing arm, the label printer, the label applicator head, and the second dancing arm and attached at the other end to the collecting roll; the second dancing arm is displaceable to a non stretching position when no backing paper is mounted.

The first dancing arm is displaceable to a non stretching position when no backing paper is mounted.

These and other aspects of the invention will be apparent from and elucidated with reference to the embodiments described hereinafter.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates a label application system according to the present invention;

FIG. 2 illustrates a printing device according to the present invention; and

FIG. 3 illustrates a dancing arm according to the present invention.

FIG. 4 illustrates a detail of another embodiment of the present invention.

### DETAILED DESCRIPTION OF THE INVENTION

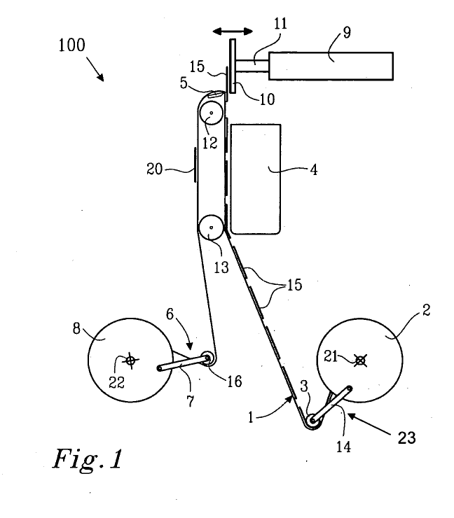

FIG. 1 illustrates a label application system 100 for application of labels to an object. The labels are stored on a protective backing paper 1 mounted on a storage roll 2 (or reel) rotatable around an axis 21. The backing paper 1 is transferred to a printing device 4 guided by a guiding roll or wheel 3 mounted on an arm 14 together form a first dancing arm 23. The backing paper 1 passes by an edge 5 providing a pressure on a back side of the backing paper 1 since the backing paper 1 is directly turned and drawn back downwards again as seen in FIG. 1. Due to of the back pressure applied to the backing paper 1, the label loosens from the backing paper 1 and continues to travel to a label applicator head 10 and adheres to the label applicator head 10, e.g. by a suction or adhesive force provided by a suction device. The suction device reduces pressure in distribution channels located on the applicator head 10 on the same side as the label will adhere to. Other suction force generating means may be utilized, such as, but not limited to, static electricity, adhesives, and similar. The applicator head 10 may be mounted on a displacement arm 11 on an actuating device 9 if the label applicator head 10 is of such a type as to press the label onto the object to be labeled, the applicator head 9, displacement arm 11, and actuating device together forming a label dispenser. Other variations of label dispensers may be used depending on the specific application process to use (for instance, a dispenser that blow the label onto to the object to be labeled using pressurized air), as understood by the person skilled in the art.

Guiding rods or rolling elements 12 and 13 provides spacing between the part of the backing paper on the way towards the label applicator head 10 and the part on the way towards a backing paper collecting roll 8. A second dancing arm 6, located downstream of the applicator head, comprise a roll or wheel 16 mounted on an arm 7 and provides a stable movement of the backing paper 1 and makes sure the backing paper 1 is stretched in a correct way during normal operation. The backing paper 1 is pressed downwards (as seen in FIG. 1) by the collecting roll 8 (sometimes called rewind bobbin) which is motorized in order to drag the backing paper from the storage roll 2 and on to the collecting roll 8. The collecting roll 8 is rotatable around an axis 22. The rolling elements 12 and 13 may also be designed as wheels.

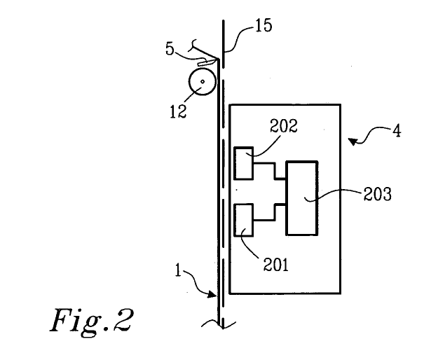

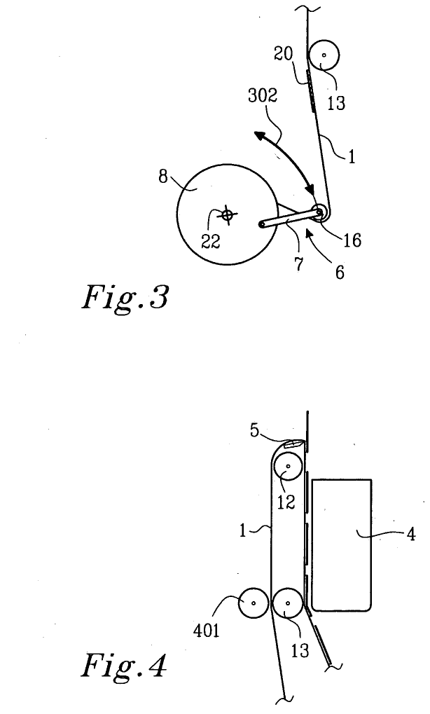

In one embodiment of the present invention the second dancing arm 6 located close to the collecting roll 8 is displaceable by a displacement device or actuator. The movement may be controlled with a control device (203 in FIG. 2) according to desired function. For instance when no backing paper 1 is present in the backing paper 1 path through the label application apparatus 100, the second dancing arm 6 may be controlled to move to a non stretching position providing a clear path to mount the backing paper. More will be discussed about this position with reference to FIG. 3 below in this description. Due to the facilitation of mounting of the backing paper, less material will be used during mounting and therefore material is saved.

In another embodiment of the present invention, the first dancing arm 23 close to the storage roll 2 is displaceable by a displacement device in order to facilitate the mounting of backing paper 1 in the label applicator apparatus 100. In yet another embodiment of the present invention both dancing arms 16 and 23 are displaceable as described above.

The printing device may comprise a controller controlling the operation of the different components of the label applicator system 100. For instance the controller may control the position of the two dancing arms 6 and 23, the rotation of the collecting roll 8, printing of the label, and detect errors in the system or breakage of the backing paper. A software program may be resident in the controller, wherein the software is arranged to acquire signals from the system, analyze and act in response to acquired signals, and control printing action. The controller may further comprise communication interface for communicating with other devices or with external computing devices, for instance for obtaining data to be printed, communicate error signals to other control devices, and so on as understood by the person skilled in the art.

The present invention comprises a cost effective and simple solution for removing erroneous RFID (radio frequency identification) tags from an inline label printing and application process.

RFID tags may be provided on or in the labels and as seen in FIG. 2 the printing device 4 may comprise an RFID initiating device 201 and/or an RFID testing device 201 (the initiating and testing device may be built into the same unit or into separate units). During the passage of the backing paper 1 in front of the initiating device 201 the RFID tag is initiated in a normal manner as understood by the person skilled in the art and can simultaneously be tested to see if it has been initiated properly and if it works properly. RFID tagged labels may of course be initiated at an earlier stage prior to passing by the printing device, e.g. at another location inline of the backing paper 1 transferring path (i.e. from the storage roll 2 to the collecting roll 8) prior to the label applicator head 10, they may be initialized during mounting of the labels onto the backing paper 1, or they may be initialized in an intermediate separate step.

If the RFID tagged label is not working properly it should be removed before being applied to an object to the labeled preferably in an automatic inline process, since this is the most cost effective way of dealing with faulty RFID tags. Removing labels (with RFID tags) from labeled objects often require manual operation which is time consuming and involve high costs. The automatic inline removal may be accomplished with several different techniques.

The collecting roll 8 together with the second dancing arm 6 provide a downward acting force on the backing paper when it is at the top most location adjacent to the edge 5. Therefore, the backing paper 1 will be pressed on to the edge 5 and the label is eased off from the backing paper 1. By reducing the downward pressing force, the backing paper 1 will take a return path with an increased radius and will therefore not be pressed on to the edge 5. This will cause the label 20 to stay on the backing paper 1 instead of being peeled off to the applicator head 10. Since the label 20 remains on the backing paper 1 it will be collected on the collecting roll 8 and thus not applied to the object.

In an embodiment the reduction of downward acting force may be accomplished by moving the second dancing arm 6 to a position so as to reduce the stretching function momentarily. The second dancing arm 6 is mounted on an arm 7 which is movable in a direction around an axis providing a movement 302 (see FIG. 3) so as to reduce the curvature of the backing paper 1 when reducing the force pressing on the backing paper 1 downwards. If during initialization and testing the RFID tag is found erroneous, a control signal is sent to the processing device 203. The processing device 203 control the location of the second dancing arm 6 by controlling an actuating device (not shown) in mechanical contact with the second dancing arm 6. The actuating device displaces the second dancing arm 6 in a direction reducing the tension on the backing paper 1 when a label is to be stopped from being delivered to the applicator head 10, or the dancing arm is displaced towards a tensioning direction during normal operation (i.e. tensioning of the backing paper 1 when the dancing arm presses on the backing paper 1). The actuating device may provide the directive force to urge the second dancing arm 6 towards the tensioning position or a spring may provide the directive force. The slackening of the backing paper 1 is only necessary until part of the label has passed the edge 5, depending on type of label, e.g. geometry and thickness, a different length of the label need to pass the edge 5 before tension may be applied again. The processing device may comprise instruction sets for controlling the function of the system, for instance:
an instruction set for receiving a signal from an RFID testing device;
an instruction set for sending a signal to an actuator controlling a tension controlling device controlling tension on a label backing paper;
an instruction set for sending a signal to the actuator indicative of a reduction of tension on the label backing paper if the RFID testing device detects a faulty RFID tag.

The actuator controlling the second dancing arm 6 may comprise a stepper motor connected to the second dancing arm 6 via a gear box or directly; however, it may of course comprise other actuating devices acting directly or via a transmission system. Other actuating devices may for instance be linear displacement devices, pneumatic device, or electrical motors. The second dancing arm 6 is attached to the actuating device (directly or indirectly) at a pivotal point. It may also be attached to the actuating device in any other suitable position as understood by the person skilled in the art.

An extra benefit using such an actuating device is that the dancing arm may be mechanically controlled in case of a backing paper 1 breakage. In such a case the dancing arm would normally (due to the spring load) very rapidly travel in one direction and possible injure anyone present in the travel direction or the second dancing arm 6 may itself be damaged due to rapid and strong forces present. It is another advantage of the present invention using the actuating device, that it is possible when no backing paper 1 is present, to have the dancing arm 6 move to a position facilitating loading/mounting of the backing paper 1 onto the collecting roll 8.

Any type of applicator head or label applicator principle may be used according to the present invention, such as pressing label applicator principles (wherein the applicator head 10 presses the label onto the object with a force) or blow applicator principles (wherein the label is urged to travel a distance in the air over to the object by a pressure “impulse” pressing on the non sticky side of the label).

In another embodiment of the present invention, the backing paper 1 is temporarily slacked by running the collecting roll 8 backwards and at the same time stopping the dancing arm 6 from tensioning the backing paper 1. This will provide the same effect so as to slacken the backing paper 1 enough for the label to partly pass by the edge 5 and therefore stopped from being transferred to the applicator head 10.

In yet another embodiment of the present invention illustrated in FIG. 4, a breaking wheel or roller 401 is provided for breaking and even backing the backing paper 1 movement in order to reduce the tension and allow for a larger radius of the backing paper 1 turning at the location of the edge 5. The backing paper 1 is steered using the rolling elements 12 and 13 and the breaking roller is during normal operation turning with the same speed as rolling element 13 and turning in such a way so as to provide a following movement with rolling element 13. However, if a label is to be removed due to erroneous behavior the breaking roller 401 will turn in an opposite direction so as to provide a breaking force on the backing paper 1. In order to facilitate this function the collecting roll 8 may be stopped from turning since the collecting roll provide the dragging force drawing the backing paper 1 from the storage roll 2 to the collecting roll 8 via steerage elements 3, 12, 13, and 6 and printer elements 4. At the same time it may be further facilitated by activating a stop function of the second dancing arm 6 in order hinder the second dancing arm 6 from increasing the tightening force.

It should be understood by the person skilled in the art that other processes in the labeling process may need to be controlled, paused, or in any other suitable way handled during the removal of the faulty label depending on the actual delay of the labeling process due to the removal of the fault RFID tagged label. For instance, for objects arriving in front of the label applicator head 10 on a conveyor belt, the conveyor belt should be stopped or reduced in speed so as to allow for the removal of the label and the arrival of a new label to be attached to the object, before the conveyor belt may be started again or have the speed increased again.

A second test may be utilized, wherein RFID labels labeled onto objects are tested again in order to deduce the RFID functionality. This is a separate process not part of the label application system 100; however, the same control system may be utilized for this “after” control and for providing alarm signals or action signals in order to deal with faulty RFID tags at this stage of the labeling process. These alarm signals may be provided to an operator or an automatic surveillance system (not shown) for appropriate action. The action signal or signals may be provided to an automatic handling system, removing the object from the conveyor belt or otherwise removing it from the normal handling system and/or process.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented by means of both hardware and software, and that several “means” may be represented by the same item of hardware. Any direction wording such as front, down, up, downwards, or upwards are only for illustrative purposes with reference to figures and is depending on how devices are mounted and used in a real world application.

The above mentioned and described embodiments are only given as examples and should not be limiting to the present invention. Other solutions, uses, objectives, and functions within the scope of the invention as claimed in the below described patent claims should be apparent for the person skilled in the art.

1. A label applicator system with means for hindering a faulty RFID tagged label to be applied to an object to be labeled, comprising:
a label applicator head;
a label comprising an RFID (Radio Frequency Identification) tag, said label stored on said label backing paper;
an RFID test device; and
means for applying tension in a backing paper, mounted in said label applicator system, with labels attached on said backing paper;
wherein means for reducing tension is arranged to be operational if said RFID test device detects a faulty RFID tag.

2. The system according to claim 1, wherein said means for reducing tension comprise a second dancing arm applying a tension force on said backing paper and said second dancing arm arranged to be displaced to a tension reducing position when tension reduction is desired.

3. The system according to claim 2, wherein said second dancing arm is located adjacent to a collecting roll collecting said backing paper downstream of said label applicator head.

4. The system according to claim 1, wherein said means for reducing tension comprise a backing roll arranged to apply a tension reducing force to said backing paper by applying a counteracting direction of travel on said backing paper.

5. The system according to claim 4, wherein said means for reducing tension further comprise means for applying a displacement stop of a dancing arm, wherein said dancing arm is hindered from increasing said tension when said backing roll apply said tension reducing force.

6. The system according to claim 1, wherein said means for reducing tension comprise a collecting unit, pulling said backing paper, being arranged to invert a direction of travel of said backing paper in order to reduce tension on said backing paper.

7. The system according to claim 6, wherein said means for reducing tension further comprise means for applying a displacement stop of a second dancing arm, wherein said second dancing arm is hindered from increasing said tension when said collecting roll inverts said direction of travel in order to reduce tension on said backing paper.

8. A method of hindering a faulty RFID tagged label from being applied to an object by a label applicator system, comprising the steps of:
determining the quality of said RFID tag;
reducing tension on a label backing paper, mounted in said label applicator system, if said RFID tag is determined to be faulty;
obtaining from said step of reducing tension an increased turning radius of said label backing paper at a position of transferal to a label applicator head part of said label applicator system; and
hindering said label from being transferred to said label applicator head from said label backing paper.

9. The method according to claim 8, further comprises the step of displacing a second dancing arm to a tension reducing position from a tension applying position when tension reduction is desired, said second dancing arm is located downstream of said label applicator head.

10. A computer program for controlling a label applicator system applying RFID tagged labels to objects, comprising:
an instruction set for receiving a signal from an RFID testing device;
an instruction set for sending a signal to an actuator controlling a tension controlling device controlling tension on a label backing paper;
an instruction set for sending a signal to said actuator indicative of a reduction of tension on said label backing paper if said RFID testing device detects a faulty RFID tag.

11. The computer program according to claim 10, wherein said tension controlling device is a second dancing arm displaceable to a tension reducing position.

12. The computer program according to claim 10, wherein said tension controlling device is a collecting roll controlling travel of said backing paper and arranged to invert the direction of travel of said label backing paper.

13. The computer program according to claim 10, wherein said tension controlling device is a backing or breaking roll located downstream of a label applicator head.

14. A label applicator system with means for facilitating mounting of label backing paper comprising:
a storage roll;
a collecting roll;
a first dancing arm located close to said storage roll;
a second dancing arm located close to said collecting roll;
a label applicator head; and
a backing paper with labels attached,
wherein said backing paper is attached at one end to said storage roll, and mounted in a path passing said first dancing arm, said label printer, said label applicator head, and said second dancing arm and attached at the other end to said collecting roll; said second dancing arm is displaceable to a non stretching position when no backing paper is mounted.

15. The label applicator system according to claim 14, wherein said first dancing arm is displaceable to a non stretching position when no backing paper is mounted.
